(19) United States
(12) Patent Application Publication
(10) Pub. No.: US 2023/0211999 A1
(43) Pub. Date: Jul. 6, 2023

(54) ADJUSTABLE HAND GRIP FOR EQUESTRIAN REIN

(71) Applicant: Holli A. Adams, Tryon, NC (US)

(72) Inventors: Holli A. Adams, Columbus, NC (US); Darren H. Tedder, Canton, GA (US); David J. Gearing, Pillager, MN (US)

(21) Appl. No.: 18/080,172

(22) Filed: Dec. 13, 2022

Related U.S. Application Data
(60) Provisional application No. 63/294,933, filed on Dec. 30, 2021.

(51) Int. Cl. B68B 1/04

(52) U.S. Cl. CPC B68B 1/04

(57) ABSTRACT

An adjustable hand grip configured to secure to an equestrian rein is provided. The hand grip may be shaped to conform to a closed palm of a rider's hand and may provide an ergonomic hand grip that may be securely located at the rider's desired rein position.

This application claims priority to and/or the benefit of U.S. Provisional Patent Application No. 63/294,933, filed 30 Dec. 2021, which is incorporated herein by reference in its entirety.

Embodiments of the present disclosure relate generally to equestrian tack equipment and, more particularly, to an adjustable hand grip that can be selectively secured at any one of multiple locations along the length of a rein.

### BACKGROUND

Rider control of a horse is typically achieved, at least in part, by a bridle to which elongate left and right reins are attached. The rider may independently manipulate (e.g., pull) the left and right reins (using the rider's left and right hands, respectively) to influence animal movement.

In general, reins are of a length that accommodates a wide range of rider and animals sizes. The exact position at which an individual rider may grip each rein may then be dictated by the rider's ability, preferences, and physical attributes.

### SUMMARY

Embodiments described herein may provide an adjustable hand grip for an equestrian rein having a housing comprising an outer surface and opposing, first and second inner surfaces, the first and second inner surfaces at least partially defining a passageway passing through the outer surface of the housing from a first side of the housing to a second side, the passageway configured to receive the rein. A clamp associated with the first inner surface may also be provided, wherein the clamp is configured to effectively move toward, and alternatively, away from the second inner surface, and wherein the clamp is configured to selectively immobilize the rein when the rein is positioned within the passageway between the first and second inner surfaces. The outer surface of the housing includes one or more grip surfaces shaped to conform to the shape of a closed hand of a rider.

In another embodiment, an adjustable hand grip for an equestrian rein is provided that includes a housing having an outer surface and opposing, first and second inner surfaces, the first and second inner surfaces at least partially defining a channel passing through the outer surface of the housing, wherein the channel is configured to permit the rein to pass laterally into the channel from outside the housing to a location between the first and second inner surfaces. A clamp associated with the first inner surface is further provided, wherein the clamp is configured to effectively move toward, and alternatively, away from the second inner surface, and wherein the clamp is configured to selectively immobilize the rein when the rein is passed through the slot and placed between the first and second inner surfaces. The outer surface of the housing includes one or more grip surfaces shaped to conform to the shape of a closed hand of a rider.

In yet another embodiment, an adjustable hand grip for an equestrian rein is provided including a housing having an outer surface, wherein a passageway extends through the outer surface of the housing from a first side of the housing to an opposite second side. The passageway is configured to receive the equestrian rein therein. A clamp is also included and associated with the housing. The clamp includes a first inner surface configured to effectively move toward, and alternatively, away from an opposing, second inner surface. The clamp is configured to selectively immobilize the rein when the rein is positioned within the passageway between the first and second inner surfaces. The outer surface of the housing also defines one or more grip surfaces adapted to conform to an interior shape of a palm of a closed human hand.

In still another embodiment, an adjustable hand grip for an equestrian rein is provided that includes a housing having an outer surface and opposing, first and second inner surfaces, the first and second inner surfaces at least partially defining a channel passing through the outer surface of the housing. The channel is configured to permit the rein to pass laterally into the channel from outside the housing to a location between the first and second inner surfaces. A clamp is also provided and includes a clamp member associated with the first inner surface, the clamp member configured to effectively move toward, and alternatively, away from the second inner surface, wherein the clamp is configured to selectively immobilize the rein when the rein is passed through the channel and placed between the first and second inner surfaces. The outer surface of the housing includes one or more grip surfaces shaped to conform to an interior shape of a palm of a closed human hand.

In still yet another embodiment, an adjustable hand grip for an equestrian rein is provided that includes a housing having an outer surface, wherein a passageway extends through the outer surface of the housing from a first side of the housing to an opposite second side, the passageway configured to receive the equestrian rein therein. The housing further includes a frustoconical interior surface. The grip further includes a collet positioned within the housing. The collet includes a first inner surface and a frustoconical outer surface, wherein the first inner surface is configured to effectively move toward, and alternatively, away from an opposing, second inner surface, and wherein the collet is configured to selectively immobilize the rein when the rein is positioned within the passageway between the first and second inner surfaces. Still further, the outer surface of the housing defines one or more grip surfaces shaped to conform to an interior shape of a palm of a closed human hand.

The above summary is not intended to describe each embodiment or every implementation. Rather, a more complete understanding of illustrative embodiments will become apparent and appreciated by reference to the following Detailed Description of Exemplary Embodiments and claims in view of the accompanying figures of the drawing.

### BRIEF DESCRIPTION OF THE VIEWS OF THE DRAWING

Exemplary embodiments will be further described with reference to the figures of the drawing, wherein:

FIG. 1 illustrates a conventional bridle attached to a horse, the bridle including left and right reins, wherein an adjustable hand grip for an equestrian rein in accordance with various embodiments of the present disclosure is shown attached to each of the reins;

FIG. 2 is a perspective view of the adjustable hand grip of FIG. 1;

FIG. 3 is an exploded view of the hand grip of FIG. 2;

FIG. 4 is side elevation view of the hand grip of FIG. 2;

FIG. 5 is a partial section view of the hand grip of FIG. 2 taken along line 5-5 of FIG. 2;

FIG. 6 is another partial section view of the hand grip of FIG. 2 viewed along line 6-6 of FIG. 4;

FIG. 7 illustrates a portion of an adjustable hand grip for an equestrian rein in accordance with another embodiment of the present disclosure;

FIG. 8 illustrates an adjustable hand grip for an equestrian rein in accordance with still another embodiment of the present disclosure;

FIG. 9 is a section view taken along line 9-9 of FIG. 8;

FIG. 10 illustrates a portion of an adjustable hand grip for an equestrian rein in accordance with still yet another embodiment of the present disclosure;

FIG. 11 is a side elevation view of the hand grip of FIG. 10;

FIG. 12 is an isolated view of a clamp member for use with the hand grip of FIGS. 10-11;

FIG. 13 is an end view of the hand grip of FIG. 11;

FIG. 14 is an end view of an adjustable hand grip in accordance with another embodiment of the present disclosure;

FIG. 15 is a perspective view of an adjustable hand grip for an equestrian rein in accordance with still another embodiment of the present disclosure;

FIG. 16 is an exploded perspective view of the hand grip of FIG. 15; and

FIG. 17 is a section view taken along line 17-17 of FIG. 15.

The figures are rendered primarily for clarity and, as a result, are not necessarily drawn to scale. Moreover, various structure/components may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way. Finally, exemplary embodiments are described herein with reference to the figures of the drawing, wherein like reference numerals designate like parts and assemblies throughout the several views.

### DETAILED DESCRIPTION OF EXEMPLARY EMBODIMENTS

In the following detailed description of illustrative embodiments, reference is made to the accompanying figures of the drawing which form a part hereof. It is to be understood that other embodiments, which may not be described and/or illustrated herein, are certainly contemplated.

All headings provided herein are for the convenience of the reader and should not be used to limit the meaning of any text that follows the heading, unless so specified. Moreover, unless otherwise indicated, all numbers expressing quantities, and all terms expressing direction/orientation (e.g., vertical, horizontal, parallel, perpendicular, etc.) in the specification and claims are to be understood as being modified in all instances by the term “about.” The term “and/or” (if used) means one or all of the listed elements or a combination of any two or more of the listed elements. The term “i.e.” is used as an abbreviation for the Latin phrase id est and means “that is.” The term “e.g.” is used as an abbreviation for the Latin phrase exempli gratia and means “for example.”

It is noted that the terms “have,” “include,” “comprise,” and variations thereof, do not have a limiting meaning, and are used in their open-ended sense to generally mean “including, but not limited to,” where the terms appear in the accompanying description and claims. Further, “a,” “an,” “the,” “at least one,” and “one or more” are used interchangeably herein. Moreover, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like may be used herein and, if so, are from the perspective shown in the particular figure. These terms are used only to simplify the description, however, and not to limit the interpretation of any embodiment described. In a similar manner, terms such as “first” and “second” may be used herein to describe various elements. However, such terms are used only to simplify the accompanying description and are not intended to indicate that embodiments having only one such element (or more than two such elements) are excluded.

Further, it is understood that any particular element that is described as connected or coupled to another element is understood to be either directly connected or coupled, or indirectly connected or coupled via intervening components.

The terms “horse” and “equine” (and variations thereof) are used broadly herein to refer to not only any animal within the horse family (Equidae taxonomy including, e.g., horses, ponies, donkeys, mules, etc.), but also to any other domesticated or semi-domesticated animal to which a bridle or lead may be attached for the purpose of riding or controlling the animal.

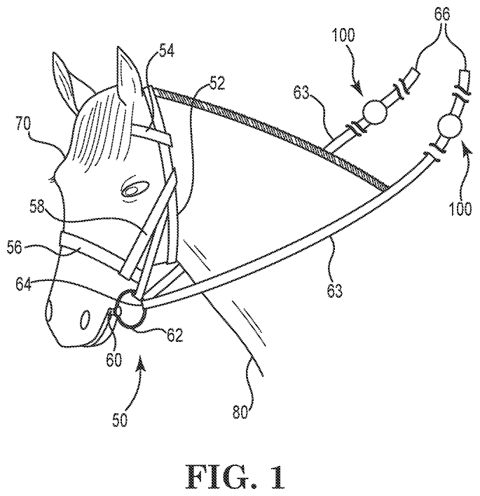

Among the equipment (tack) commonly used by equestrians during riding is a bridle, an example of which is shown in FIG. 1 attached to a horse 80. While variations exist, an exemplary bridle 50 consists of several components, including: various straps (e.g., throatlatch 52, brow band 54, noseband 56, and cheek piece 58) that attach to a head 70 of the horse 80. The bridle 50 may support a bit 60 positioned within the horse's mouth and extending outwardly from each side thereof (only left side visible in FIG. 1). A ring 62 may be attached on each protruding side (left and right) of the bit 60. The various components of the bridle may then connect to the rings 62 as shown.

To allow rider control, elongate left and right straps or “reins” 63 may be provided as shown. In general, each rein has a first end 64 attached to the corresponding ring 62 of the bit 60 and extends rearwardly (e.g., toward the rider's location on the horse's back) to terminate at respective second ends 66. In some instances, the second ends 66 of the reins 63 may attach to one another, although keeping the second ends detached is common. Some or all of the various straps of the bridle 50 described and illustrated herein are typically leather, although other materials (e.g., nylon) are also available.

During riding, the rider may independently pull upon the left and right reins 63, which commands the horse to move in a desired manner. As one can appreciate, such constant interaction with the reins may benefit from the rider being able to consistently position his or her hands along each rein and maintain hand position during riding. To accommodate such hand positioning, many trainers and riders are known to tie a knot in each rein 63 at a location that provides a rein length best suited for the particular rider. In addition to locating each hand along its respective rein, rein knots may also conveniently provide an enlarged surface for which to grip the rein.

While knotting is effective at setting hand/rein position, such knots can sometimes loosen and move or slip over time, which may necessitate periodic checking and adjustment of the knot. Moreover, knotting of reins, as well as placing the knot at the desired location along the rein, may present issues. For example, the relatively stiff leather common with new reins can make it difficult to form a relatively tight knot, as well as locate that knot at the desired location. Still further, until the leather “breaks in,” such knots may, as stated above, slip along the rein as forces are applied to the knot by the rider.

Embodiments of the present disclosure seek to address these and other issues by providing an adjustable hand grip for an equestrian rein that may attach to each rein as described below. More particularly, exemplary hand grips in accordance with embodiments of the present disclosure may be embodied as a detachable device that can be selectively secured to the rein at most any location (e.g., anywhere along a length of each rein 63) and may be readily removed and/or relocated along the rein as needed. Still further, such hand grips may perform well with both new and well-used reins, potentially avoiding, or at least reducing, the slippage sometimes associated with knotted reins.

While not wishing to be bound to any particular construction, exemplary hand grips may be configured as a separate device attachable to each rein (see, e.g., adjustable hand grip 100 in FIG. 1), wherein each device includes a housing configured to be received and gripped comfortably within the rider's hand. That is to say, the housing of the adjustable hand grip may form an outer surface having one or more grip surfaces (e.g., curved grip surfaces) adapted to conform to an interior shape of a palm of a closed hand of the rider. Stated yet another way, the outer surface of the grip may be ergonomically shaped such that the hand grip is comfortably received within, and conforms to a shape of, the palm of the rider's hand. As used herein, “conforms” refers to the ability of the hand grip to be comfortably received and tightly gripped within the palm of a typical human hand for extended periods of time (e.g., 20 minutes or more, one hour or more) while causing little or no additional (as compared to gripping the rein directly) hand fatigue.

While the housing shape may vary, it may in some embodiments be generally spherical in shape as further described below. As a result, the hand grip may be held by the rider against the palm and the fingers by wrapping his or her fingers about the hand grip. When so gripped, the rein may extend outwardly from the hand between the thumb and forefinger on one side, and between the ring finger and little finger (or between the little finger and the palm) on the opposite side. Such a configuration may provide a similar overall feel to riders accustomed to rein knots.

As further described below, the housing of the hand grip may include a passageway that forms a slot or channel extending through a portion of the housing to permit lateral or “side-loading” of the hand grip over the rein. That is to say, the channel may permit the rein to pass laterally (as opposed to longitudinally) into the passageway from outside of the housing. Such a construction may allow quick and simple attachment of the hand grip to the rein without “threading” of the second end 66 of the rein (see. FIG. 1) through the hand grip. However, embodiments intended for threaded rein attachment are also contemplated.

As will become evident from the following description, adjustable hand grips in accordance with embodiments of the present disclosure may allow riders to establish a repeatable hand position along each rein that is not subject to the issues that may occur with knotted reins (e.g., variability in knot location, slipping, leather stiffness, etc.).

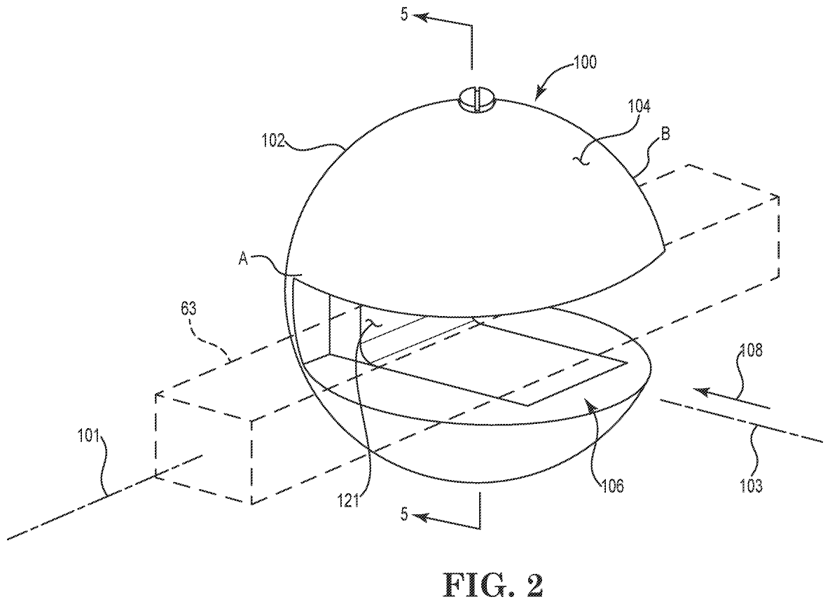

FIG. 2 illustrates an adjustable hand grip 100 for use with an equestrian rein 63 (rein shown diagrammatically in broken lines in FIG. 2) in accordance with embodiments of the present disclosure. As shown in this view, the hand grip 100 may include a housing 102 that defines an outer surface 104 having a generally spherical shape that is sized and configured to be comfortably received within the enclosed palm/hand of a rider. The housing may further define a passageway extending or otherwise passing through the outer surface 104 of the housing from a first side A to an opposite second side B to receive the equestrian rein 63 as described herein. In the illustrated embodiment of FIG. 2, the passageway is defined by a U-shaped channel or slot configured to permit the insertion of the rein 63 through a side of the housing such that the rein may pass laterally into the passageway from outside the housing. That is to say, the rein 63 may be “side-loaded” into the hand grip 100 (in the direction 108) by passing the rein into the channel 106 formed in the housing. While shown with a slot-like side-loading channel 106 extending through the outer surface of the housing, other embodiments may utilize a housing that instead defines an aperture enclosed by the housing and through which the rein may be threaded. As used herein, the terms “axial,” “longitudinal,” and variations thereof refer to a longitudinal direction or axis 101 of the passageway/rein, while “lateral,” “transverse,” and variations thereof refer to a direction 103 lateral or transverse to the longitudinal direction.

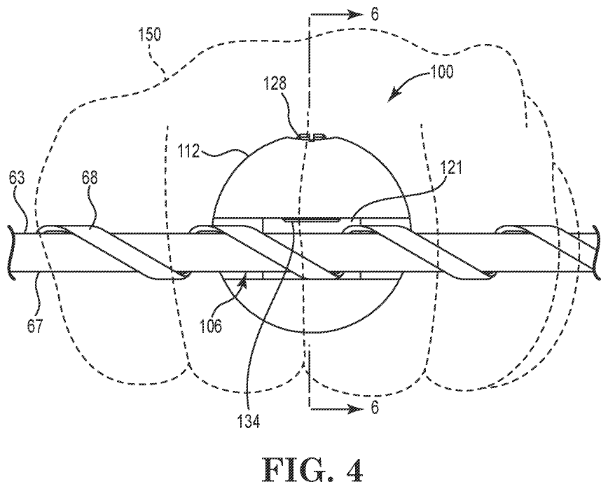

While the illustrative hand grip 100 is shown as spherical in shape, the housing 102 may be of most any configuration that provides comfortable and ergonomic gripping surfaces (as presented by the outer surface 104) for the rider. Accordingly, housings that have any curved surfaces including any one or more of spherical, hemispherical, cylindrical, obround, ellipsoid, scalloped (to receive the rider's fingers) surfaces or most any other surface shape that generally conforms to an interior shape of the palm of the rider's hand (i.e., a shape that presents a smooth and comfortably gripping surface) are also contemplated. Moreover, while the actual size of the housing 102 may be configured to accommodate a wide range or riders, a range of hand grips of differing sizes is also contemplated. As an example, FIG. 4 illustrates how the outer surface(s) 104 of the exemplary hand grip 100 defines one or more grip surfaces adapted to at least partially conform to an interior shape of a palm of a closed human hand 150 (hand shown in broken lines in FIG. 4).

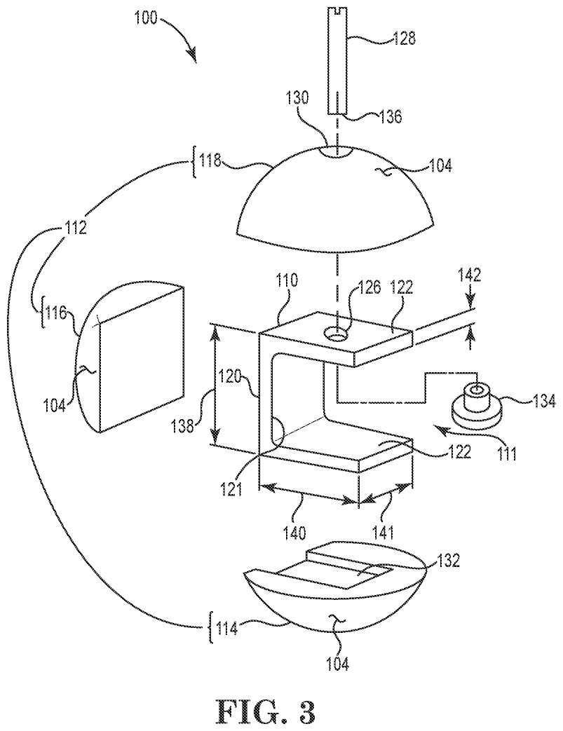

FIG. 3 is an exploded view of the hand grip 100 of FIG. 2. As shown in this view, the housing may in some embodiments be formed by a frame 110 and a body 112 attached or otherwise secured to the frame. The body 112 may, in some embodiments, be constructed of separate components (e.g., lower body section 114, rear body section 116, and top body section 118) that, when secured to the frame 110, provide the uniform (e.g., spherical) outer surface 104 of the grip as best shown in FIG. 2. That is to say, the body sections 114, 116, 118 form a portion of the housing 102 and together define the outer surface 104.

While not wishing to be bound to any particular shape, the frame 110 may be configured as a U-shaped channel as shown in FIG. 3 having a base 120 and two protruding legs 122. The U-shaped channel may provide not only the desired opening 111 (e.g., passageway/channel 106; see FIG. 2) through which a rein may be received, but also the desired structural rigidity beneficial to clamping or pressing against the rein as further described below.

The frame 110 may include a threaded aperture 126 passing through one (e.g., the top) leg 122. The aperture 126 may have a thread that corresponds to the thread of a fastener, e.g., grub screw 128, such that the screw 128 may threadably engage the aperture 126 when the hand grip is assembled. The top body section 118 may, in turn, include an opening 130 through which the screw 128 may pass with clearance.

In some embodiments, one or more of the body sections (e.g., body sections 114 and 118) may include recesses 132 (only recess in body section 114 is visible in FIG. 3) into which the frame 110 (e.g., legs 122) may seat. Accommodating the frame within the body in this fashion may provide for secure interconnection of the frame to the body sections and reduce or eliminate separate thereof during use. While not illustrated, the rear body section could also include a recess to accommodate the base 120 of the frame 110.

In some embodiments, the body sections 114, 116, and 118 may be secured to the frame 110 via any acceptable method. For example, the sections could be secured to the frame 110 via fasteners (not shown). In other embodiments, the body sections 114, 116, and 118 may be secured to the frame 110 using appropriate adhesives (e.g., multi-part epoxy, glue, etc.). While described as separate components secured to one another, such a construction of the housing 102 is exemplary only. For example, in still other embodiments, the body sections and frame could be formed together, i.e., the housing (frame and body) could be constructed as a unitary component.

As illustrated in FIG. 3, the hand grip 100 may further include a thrust member or pad 134. The thrust pad may be secured or otherwise connected to an end or thrust point 136 of the grub screw 128 (after the latter is threaded into the aperture 126). In some embodiments, the thrust pad 134 may connect to the screw 128 such that spherical movement of the pad (relative to the screw) may occur during rein clamping as further described below. As a result, the thrust pad 134 may define a first inner clamp member (or surface) of a clamp associated with the housing, wherein the first inner surface is configured to move toward, and alternatively, away, from an opposing second inner surface (e.g., opposing lower leg 122), and wherein the clamp is configured to selectively immobilize the rein 63 when the rein is positioned within the passageway between the first and second inner surfaces.

While not wishing to be bound to any specific configuration, the frame 110 may, in one embodiment be an aluminum U-channel, wherein a length 138 of the base 120 and a length 140 of each leg 122 is one inch (in), with a thickness 142 of both the base and legs being ⅛ in and a width 141 being 0.8 in. The body 112 (e.g., each of the body sections), on the other hand, may be constructed of a rigid plastic to minimize weight. In still other embodiments, the body 112 may be made of a somewhat softer material (e.g., rubber), or could include a softer outer layer over a harder material (e.g., an overmolded layer of rubber). In some embodiments, the body may form a sphere having a diameter of 1.2 in to 2 in, e.g., 1.6 in. However, this diameter, as well as the dimensions of the frame are exemplary only as other hand grip sizes (and hand grips of other materials) are certainly contemplated.

The grub screw 128 may include the thrust point 136 to permit connecting of the screw to the thrust pad 134. For example, in some embodiments, the screw 128 may conform to DIN standard 6332, while the mating thrust pad 134 may conform to DIN standard 6311. As further described below, the thrust pad may form a clamp surface or member (actuated by the screw 128) that is used to secure the rein 63 relative to the hand grip 100 (e.g., press or clamp the rein against the second inner surface, e.g., lower leg 122).

FIG. 4 is a side elevation view of the hand grip 100 with a rein 63 shown positioned within the hand grip before clamping of the rein. As shown in this view, it is common for reins to include not just a leather strap 67, but also a one or more laces 68 that are then threaded along the length of the strap via holes formed therein. As is visible in FIG. 4, the grub screw 128 (and thus the thrust pad 134) may be retracted sufficiently to permit the rein 63 to pass into the U-shaped passageway or channel 106. In some embodiments, the rein 63 may be inserted until it contacts an interior face 121 of the base 120 (see also FIG. 2).

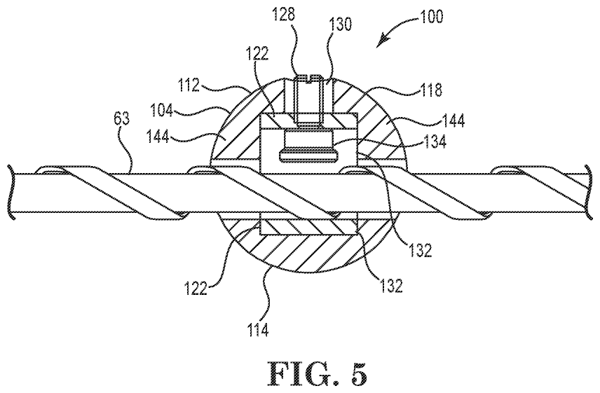

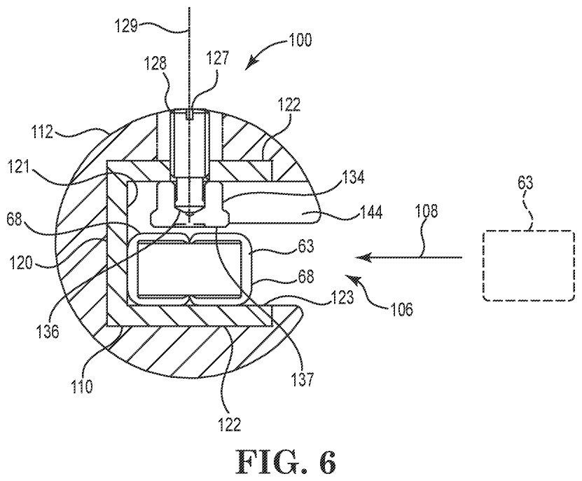

FIG. 5 is a partial section view from the same viewpoint as FIG. 4 but taken along line 5-5 of FIG. 2. As shown in this view, the lower leg 122 of the frame 110 may seat within the recess 132 formed in the lower body section 114, while the upper leg 122 is similarly engaged within the recess of the top body section 118. In some embodiments, however, the recess 132 of the top body section 118 may be deeper than the recess of the lower body section as shown in FIG. 5. Such a configuration may permit the outer surface 104 of the top body section118 to extend more completely about the hand grip as indicated by side portions 144 of the top body section 118, potentially providing a more comfortable gripping surface (one side portion 144 also visible in FIG. 6).

FIG. 6 is a partial section view taken along line 6-6 of FIG. 4 (i.e., orthogonal to the section view shown in FIG. 5). As shown in this view, the thrust point 136 of the grub screw 128 may engage the thrust pad 134 and be secured in place via a snap ring or the like associated with the thrust pad. The engagement surfaces of the thrust point 136 and thrust pad 134 may be spherical in shape to permit the thrust pad to swivel relative to an axis 129 of the grub screw 128 (wherein the axis may be orthogonal to the second inner surface (e.g., lower leg 122)). As a result, the thrust pad 134 may accommodate clamping situations wherein an edge of the thrust pad engages the rein 63 partially on a lace 68 (rather than squarely upon a lace, or between laces). Moreover, the exemplary grub screw/thrust pad construction allows rotational movement of the grub screw 128 (as the screw is turned) without causing corresponding rotation of the thrust pad 134. Accordingly, the thrust pad 134 may be tightened or clamped against the rein without abrading the rein as might occur from forced rotation of the thrust pad during clamping.

To attach the exemplary hand grip 100 to the rein 63, the screw 128 may first be rotated to retract the thrust pad 134 to provide adequate clearance for the rein to be received between the thrust pad and the lower leg 122 as shown in FIG. 6. The screw 128 may include a tool-receiving portion 127 as shown in FIG. 6 to permit use of a tool to rotate the screw. For example, the tool receiving portion 127 may include a slot adapted to receive a flat-head screwdriver as is known in the art. In alternative embodiments, the tool-receiving portion 127 may be configured to receive: a Philips-head screwdriver; or a hex (Allen) or another male (or female) key wrench.

Once the thrust pad is retracted, the rein 63 may be laterally or side-loaded into the channel 106 of the housing 102 as represented by direction 108 in FIGS. 2 and 6. In some embodiments, the rein may be inserted into the channel 106 until it contacts the interior face 121 of the base 120 as shown in FIG. 6. At this point (or before side-loading), the hand grip 100 may be located along the rein at the desired location for the particular rider, such location being selected by the rider and/or trainer.

When the hand grip is located at the desired location along the rein, and the rein is inserted into the housing 102 as described above, the grub screw may be tightened. For example, a screwdriver may be engaged with the tool-receiving portion 127 and the tool rotated in the appropriate direction to cause the thrust pad to move toward the rein 63. The screw may be tightened until the rein is securely restrained within the grip 100.

While the compliance (compressibility) of the rein 63 may provide a sufficient preload to minimize loosening of the screw over time, other embodiments may provide additional features such as a nylon insert (or a thread-locking compound applied) in the aperture 126 (see FIG. 3) to assist with preventing loosening of the screw.

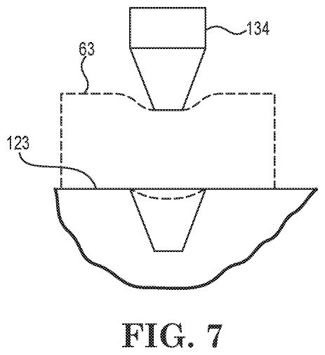

The clamping members, which may include a face 137 of the thrust pad 134 and an interior clamping surface 123 of the lower leg 122 opposing the thrust pad 134 (see FIG. 6) may include friction elements to assist with clamping and holding the rein 63 relative to the hand grip 100. For example, either or both of the face 137 and surface 123 may form an abraded or sandpaper-like surface to assist with gripping of the rein. Alternatively, the thrust pad and/or the surface 123 may include a crosshatched pattern, serrations, and/or other small protruding elements that assist with gripping the rein. In still other embodiments, the clamping members may include coordinated features. For instance, the thrust pad 134 shown in FIG. 7 may form one or more male shapes (e.g., one or more pyramidal or V-shaped elements) that oppose one or more correspondingly female-shaped depressions formed on or in the surface 123. These and other embodiments of the clamping members may assist with reducing slippage of the rein relative to the grip once clamped.

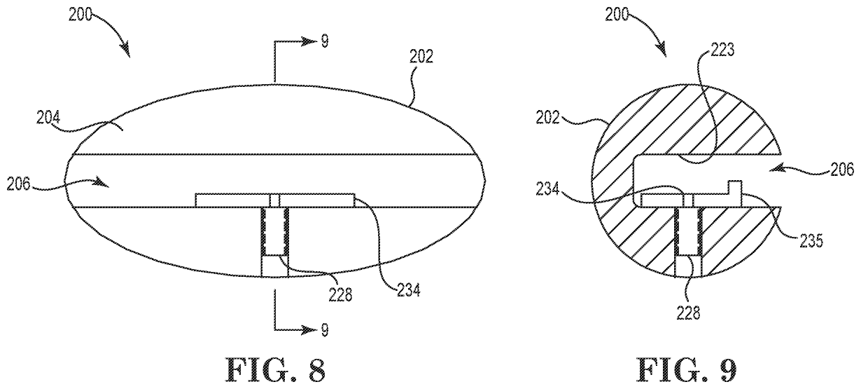

While the exemplary hand grip 100 is described in detail above, other embodiments and variations of the grip are also contemplated. For example, FIGS. 8 and 9 illustrate a hand grip 200 in accordance with another embodiment of the present disclosure. As shown in FIG. 8, the hand grip 200 has a housing 202 forming an outer surface 204 and again having a passageway defined by a U-shaped, side-loading channel 206 similar to the channel 106 already discussed above. As with the grip 100, the grip 200 further includes a set screw 228 that attaches to a movable clamping member (first inner surface), e.g., thrust member or pad 234, configured to secure a rein (not shown) against an opposing clamp member, e.g., second inner or clamping surface 223.

Unlike the grip 100, the grip 200 may form an ellipsoid shape as shown in FIG. 8. Such a shape may present an outer surface that some riders may find more comfortable. Moreover, the grip 200 may also provide an elongate thrust pad 234 compared to the thrust pad 134 associated with the grip 100. The elongate thrust pad 234 may provide more surface area contact of the clamp members with the rein, potentially providing the same clamping force with less pressure on the rein itself. As shown in FIG. 9, the thrust pad 234 may also include a lip 235 such that the thrust pad has a generally L-shaped end view as shown. The lip 235 may assist with maintaining the rein in an aligned position relative to the grip during and after attachment.

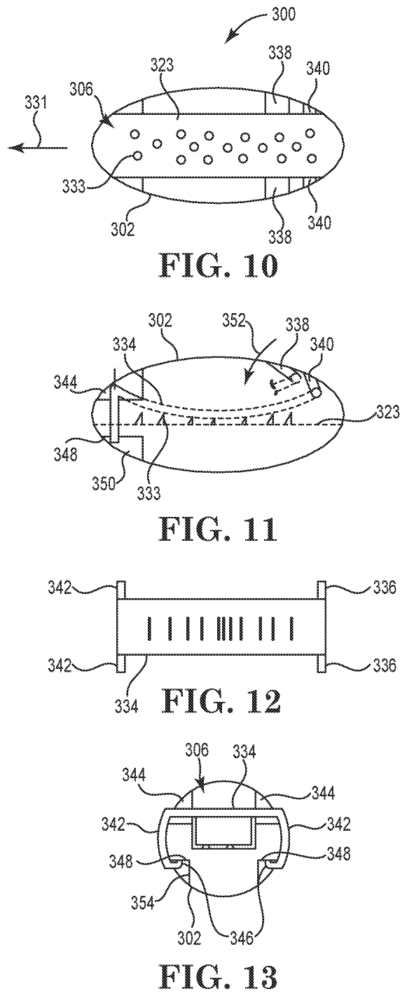

FIGS. 10-13 illustrate a hand grip 300 in accordance with still another embodiment of the present disclosure. Unlike the hand grips 100 and 200 described above, the hand grip 300 may use a clamp that includes a first inner surface formed by a spring biased clamp member 334 as opposed to the thrust pads 134 and 234. Once again, the first inner surface (e.g., the clamp member 334) is configured to move toward, and alternatively, away, from an opposing second inner surface (e.g., clamp surface 323), wherein the clamp is configured to selectively immobilize the rein 63 (not shown) when the rein is positioned within the passageway (e.g., channel 306) between the first and second inner surfaces as further described below. Like the grip 100, the grips 200 and 300 may also provide an outer surface of the housing that defines one or more grip surfaces adapted to conform to an interior shape of the palm of a closed human hand.

As shown in FIG. 10, the grip 300 includes a housing 302 that, like the housing 202, is ellipsoid in shape. The housing may also define a passageway defined by a U-shaped channel 306 in which the rein (not shown) may be received. Unlike the other grips illustrated herein, the channel 306 may be configured to receive the width (rather than the thickness) of the rein such that the rein may be laid flat against a clamp surface 323 of the housing 302. As with the other embodiments described herein, the clamp surface 323 (and/or the clamp member 334) may include friction elements, e.g., saw tooth serrations 333, to reduce relative slippage of, or otherwise assist with gripping, the rein. In some embodiments, the serrations 333 may be unidirectional in that they are angled in one direction and are designed to bite into the rein when the rein is pulled in one direction 331 yet may disengage partially when the rein is pulled in the opposite direction. In other embodiments, the serrations may be bidirectional (e.g., bite into the rein regardless of rein pull direction).

The grip 300 further includes the spring biased clamp member 334 forming a first inner surface of the clamp as shown in FIGS. 11-13. The clamp member 334 may be configured as a piece of formed spring steel, e.g., formed with a bow as shown in FIG. 11. At a first end of the clamp member, legs 336 may protrude outwardly as shown in FIG. 12. Each of the legs 336 may be received into (e.g., pivotally attached to) a corresponding first slot 338 or a corresponding second slot 340 of the housing. The first slot 338 may be shallow (offset a first distance from the clamping surface 323) as shown in FIG. 11, while the second slot is 340 is deeper (offset a second distance less than the first distance from the clamping surface 323). By selecting one of the first and second slots 338 and 340, the effective clamping force applied by the spring biased clamp member 334 may be altered (e.g., greater clamping force in the second slot as opposed to the first slot).

A second end of the clamp member 334 may form outwardly projecting clasp arms 342 as also shown in FIG. 12. The housing 302 may include cutouts 344 to accommodate the outwardly projecting clasp arms 342 as shown in FIGS. 11 and 13. As is evident in the figures, the clasp arms 342 also extend downwardly (in FIGS. 11 and 13) to define catches 346 as shown. As described further below, each of the catches 346 may engage a ledge 348 formed by cutout 350 with a snap fit, whereby the clamp member 334 is then secured in place.

In use, the rein 63 may be inserted into the channel 306 of the housing 302 (again, the slot may be sized to receive the entire width of the rein) and the grip located at the appropriate position along the rein. The legs 336 of the clamp member 334 may then be inserted into either the first slots 338 or the second slots 340. Once so inserted, the clamp member 334 may be pivoted about the legs 336 as indicated by arrow 352 in FIG. 11. As the clamp member is pivoted, the bowed portion may contact the rein (not shown) and force the rein against the clamping surface 323 of the housing 302. The rider/trainer may continue to apply force to the clamp member, e.g., a downward force to the second end of the clamp member until the catches 346, which deflect outwardly as the downward force is applied, engage the ledges 348 with a snap fit.

As one of skill can appreciate, the clamp member 334 deflects as it is moved into its latched position, causing a clamping force to be applied to the rein positioned between the clamp member and the clamping surface 323. As stated above, this clamping force may be altered by placing the legs 336 in either the slot 338 or 340. Alternatively, different spring members 334 may be provided to accommodate different spring forces or reins of different thickness.

To remove and/or relocate the grip 300, a flathead screwdriver or the like may be inserted between the catches 346 and a wall 354 of the housing 302 and twisted, thereby deflecting the catch sufficiently to disengage the same from the housing.

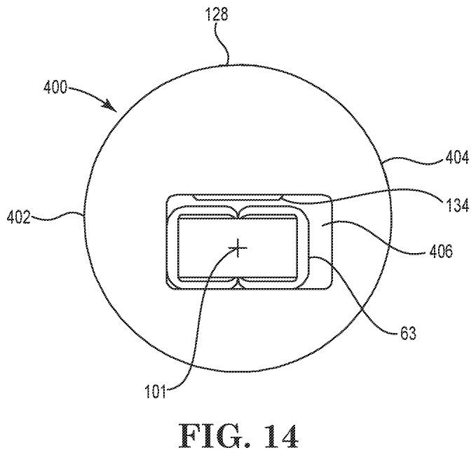

Although illustrated and described above as providing a side-loading slot (see, e.g., channel 106 of grip 100) that permits the rein to be introduced laterally into the hand grip, such a configuration is exemplary only. For instance, FIG. 14 illustrates an adjustable hand grip 400 that is similar, in many respects, to the hand grip 100 described elsewhere herein. That is, the hand grip 400 may include a housing 402 and a clamp (e.g., thrust pad 134 and screw 128) configured to secure the hand grip to the rein 63. However, unlike the hand grip 100, the hand grip 400 may have a rein-receiving passageway defined by an aperture 406 passing through the outer surface of the housing from a first side of the housing 402 to a second side (i.e., the aperture is surrounded, relative to the axis 101 of the rein/aperture, on all sides (360 degrees) by the housing 402 as shown in FIG. 14). Accordingly, instead of lateral side-loading of the rein into the hand grip as provided with the grips 100, 200, and 300, the rein 63 may be threaded completely through (passed longitudinally into) the aperture 406 of the grip 400 before clamping.

Such a construction may provide certain benefits when compared to the hand grips 100, 200, and 300. For instance, the hand grip 400 may present a more uniform (e.g., comfortable) outer surface 404 to the rider's hands (e.g., there is no exposed side-loading channel opening adjacent the rider's palm or fingers). Moreover, the enclosed aperture construction may provide a potentially more rigid housing structure (for example, a tubular (e.g., rectangular) frame may be utilized instead of the U-shaped channel frame used with the hand grip 100). Alternatively, a separate frame (like the frame 110) may be unnecessary due to the strength afforded by the enclosed housing structure of the grip 400. While illustrated as a variation of the hand grip 100, those of skill in the art will realize that the other hand grip embodiments (200 and 300) described and illustrated herein could also be modified to accommodate an axial rein-threading aperture (as opposed to a lateral side-loading slot) without departing from the scope of this disclosure.

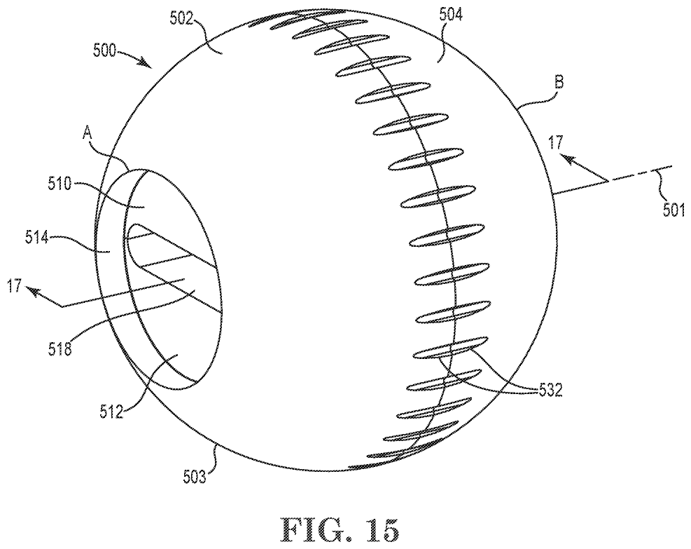

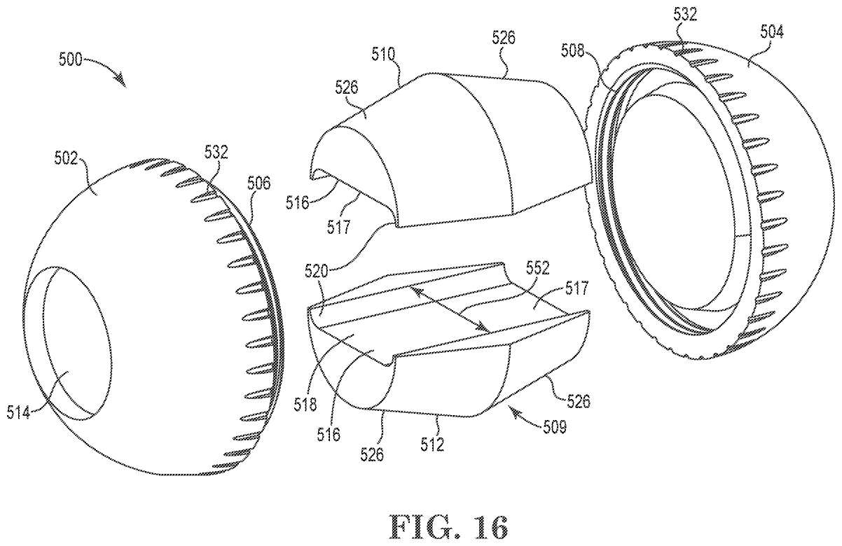

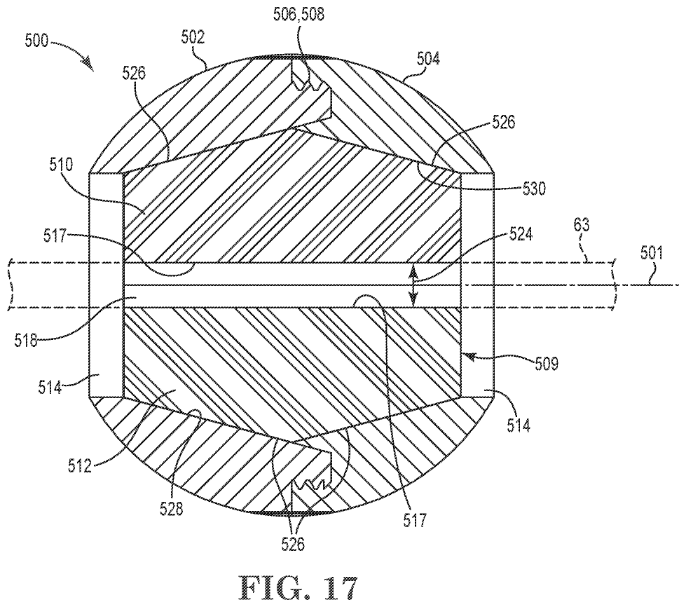

FIGS. 15-17 illustrates yet another adjustable hand grip in accordance with embodiments of the present disclosure. These views illustrate a collet-style adjustable hand grip 500 for an equestrian rein, wherein: FIG. 15 is a perspective view of the grip assembled; FIG. 16 is an exploded perspective view; and FIG. 17 is a section view taken along line 17-17 of FIG. 15 additionally showing an associated rein 63. In the exemplary embodiment shown in these figures, the hand grip 500 includes a housing 503 formed by two hemispherical halves 502, 504 that may threadably engage one another using an external thread 506 on half 502 and a corresponding internal thread 508 on half 504. The hand grip 500 may have an associated clamp formed by a collet positioned within the housing 503. In the illustrated embodiment, the collet is formed as a split collet 509 formed by two opposing (first and second) collet sections 510, 512. In use, the rein 63 may pass longitudinally (e.g., along a longitudinal axis 501 of the hand grip) into and through apertures 514 in each of the halves 502, 504 and extend between channels defined by the two collet sections 510, 512 as best shown in FIG. 17.

With reference to FIGS. 16 and 17, each of the collet sections 510, 512 may define a longitudinal channel 516 formed therein, wherein, when the two collet sections 510, 512 are assembled, the apertures 514 (along with the two channels 516) form a longitudinal passageway 518 extending entirely through the housing 503/collet 509 (e.g., from and through a first side A of the housing (see FIG. 15) to and through an opposite second side B of the housing). By forming the passageway 518 as depressed channels in each of the opposing collet sections 510, 512, positioning the rein in the appropriate position within the halves may be simplified (e.g., side surfaces 520 of the channels 516 may assist in retaining the rein 63 during attachment of the hand grip 500 thereto). The channel 516 may have a width 552 that is sufficient to receive the rein, but may have a depth 524 (when the halves are assembled and abutting one another as shown in FIG. 17) that is smaller than the rein thickness. As a result, the collet sections 510, 512 may clamp firmly against the rein before the two collet sections contact one another.

Exterior surfaces of each of the collet sections 510, 512 may define halves of two frustoconical outer surfaces 526 such that, when the collet sections are assembled, an exterior surface of the collet 509 forms two frustums: one engageable with a correspondingly frustoconical interior surface 528 of the half 502 as shown in FIG. 17; and one engageable with a correspondingly frustoconical interior surface 530 of the half 504.

To attach the hand grip 500 to the rein 63, the halves 502, 504 may be unthreaded and separated from one another. At this point, the rein may be passed through the apertures 514 of each of the halves. In reins that include buckles at the rein end, the apertures 514 may be sized to allow passage of the buckles therethrough. With the rein threaded through the two halves 502, 504 such that the threads 506, 508 face one another, the collet sections 510, 512, may be placed over the rein (and between the two halves) such that the rein extends along the passageway 518 and is sandwiched between the clamp, e.g., between first inner surface 517 of collect section 510 and opposing, second inner surface 517 of the collet section 512. The side surfaces 520 may, as stated above, assist in constraining the rein to be within the channel 516. As described below, the construction of the collet 509 and the housing 503 may allow the first inner surface 517 to effectively move toward, and alternatively, away from the opposing second inner surface 517, such that the clamp (collet 509) may selectively immobilize the rein when the rein is positioned within the passageway between the first and second inner surfaces.

While the first and second inner surfaces 517 are illustrated as being generally planar and parallel to one another, such a configuration is not limiting. For example, the inner surfaces may include opposing, mating curved (e.g., one or more mating convex/concave) inner surfaces, mating saw-tooth inner surfaces, and/or mating serpentine inner surfaces to provide potentially increased rein holding power. Moreover, any of these potential surfaces may include friction elements to increase gripping of the rein.

The two halves 502, 504 may then be brought together such that the frustoconical interior surfaces 528, 530 engage the corresponding frustoconical outer surfaces 526 of the collet 509. The threads 506, 508 of the two halves may then be threadably engaged by turning the halves relative to one another. Once the threads are engaged, the hand grip 500 may be slid along the rein 63 to the desired location. Once the hand grip is positioned, the two halves 502, 504 may be further rotated, whereby the threads 506, 508 cause the two halves 502, 504 to draw together along the longitudinal axis 501. As this longitudinal movement occurs, the engagement of the tapered, frustoconical interior surfaces 528, 530 of the two halves 502, 504 with the frustoconical outer surfaces 526 cause the two collet sections 510, 512 to move toward one another, thereby clamping the rein relative to the hand grip 500. Such movement may occur as the frustoconical surface(s) 528, 530 of the housing 503 may slide relative to the frustoconical outer surface(s) 526 of the collet 509.

As with other embodiments described herein, the hand grip 500, e.g., an outer surface of the housing 503/halves 502, 504, may include features that assist with gripping the hand grip. For example, as with the other hand grips described herein, the outer surface of the housing 503 may define one or more grip surfaces adapted to conform to the interior shape of the palm of a closed human hand (see human hand 150 shown in FIG. 4). Moreover, the outer surface of the housing 503 may again include features to assist with gripping. For instance, as shown in FIGS. 15 and 16, each half may include dimples 532 (or protrusions) spaced around the periphery of the halves. In addition to providing a gripping surface during riding, the dimples may also assist with tightening/loosening the half 502 relative to the half 504. While shown as only being located at the interface between the two halves, the dimples/protrusions could be located most anywhere on the surfaces off the hand grip 500. Moreover, other gripping features, e.g., roughened surfaces, compressible outer surfaces (e.g., such as by overmolding a polymeric layer over each half 502, 504), may be additionally or alternatively provided.

While shown as requiring passing of the rein longitudinally through the housing 503 (halves 502, 504), the hand grip 500 could also provide a lateral, side-loading channel similar to the side-loading channel 106 described above. In such an embodiment, the halves 502, 504 could each have a side-loading channel that aligns when the halves are threaded away (“unscrewed”) from one another (thus allowing the collet sections 510, 512 to also move away from one another). With the side-loading channels aligned, the rein may side-load into the hand grip as described above with the hand grip 100. Once the rein is in place, the two halves 502, 504 may be threaded together (toward each other). As this occurs, the collet sections 510, 512 could move toward one another as already described above due to the engagement of the interior surfaces 528, 530 with the frustoconical outer surfaces 526, thus clamping the grip to the rein. As relative rotation of the halves 502, 504 occurs, the side-loading channel of each half 502, 504 may rotate out of alignment with one another. A rotational stop could optionally be provided to prevent the two halves 502, 504 from separating from each other when the halves are unscrewed/loosened. As a result, the hand grip could not only be side-loaded onto the rein, but it could also remain a singular assembly (e.g., the collet sections could be retained within the housing rather than being loose, independent components) during grip attachment to and removal from the rein.

Other embodiments are also possible. For instance, the hand grip may be configured as two separate components or halves that are ultimately attached to one another to effectively secure relative to the rein. For example, the two halves may be hinged to one another such that, when open, the rein may be placed against one of first and second inner surfaces and, when the halves are closed, a clamp associated with one of the inner surfaces may immobilize the rein against the other of the inner surfaces. The two halves may be secured in the closed position by a fastener such as a screw, latch (e.g., over-center latch), magnet(s), or most any other mechanism that is capable of holding the two halves with sufficient force to prevent slippage of the rein.

Illustrative embodiments are described and reference has been made to possible variations of the same. These and other variations, combinations, and modifications will be apparent to those skilled in the art, and it should be understood that the claims are not limited to the illustrative embodiments set forth herein.

What is claimed is:

1. An adjustable hand grip for an equestrian rein comprising:
a housing comprising an outer surface wherein a passageway extends through the outer surface of the housing from a first side of the housing to an opposite second side, the passageway configured to receive the equestrian rein therein; and
a clamp associated with the housing, the clamp comprising a first inner surface configured to effectively move toward, and alternatively, away from an opposing, second inner surface, wherein the clamp is configured to selectively immobilize the rein when the rein is positioned within the passageway between the first and second inner surfaces;
wherein the outer surface of the housing defines one or more grip surfaces adapted to conform to an interior shape of a palm of a closed human hand.

2. The hand grip of claim 1, wherein the passageway is defined by a channel extending through a portion of the housing, the channel configured to permit the rein to pass laterally into the passageway from outside the housing.

3. The hand grip of claim 1, wherein the passageway defines an aperture passing through the housing, the aperture configured to permit the rein to pass longitudinally into and through the passageway.

4. The hand grip of claim 1, wherein the first and second inner surfaces are parallel to one another.

5. The hand grip of claim 1, wherein the one or more grip surfaces comprises a curved surface.

6. The hand grip of claim 5, wherein the curved surface comprises a surface selected from the group of surfaces that includes: a spherical surface; a hemispherical surface; a cylindrical surface; an obround surface; and an ellipsoid.

7. The hand grip of claim 1, wherein the housing comprises a frame and a body attached to the frame.

8. The hand grip of claim 7, wherein the frame comprises a U-shaped channel.

9. The hand grip of claim 1, wherein the clamp comprises a screw threadably engaged with the first inner surface.

10. The hand grip of claim 9, wherein an axis of the screw is orthogonal to the second inner surface.

11. The hand grip of claim 10, wherein the clamp further comprises a thrust pad secured to an end of the screw, the thrust pad comprising a clamp surface adapted to press the rein against the second inner surface.

12. The hand grip of claim 1, wherein the clamp comprises a spring biased clamp member comprising a first end pivotally attached to the housing.

13. The hand grip of claim 12, wherein the first end is configured to pivotally attach to the housing at two or more different locations.

14. The hand grip of claim 12, wherein the clamp member comprises a second end adapted to engage a portion of the housing with a snap fit.

15. The hand grip of claim 1, wherein one or both of the first and second inner surfaces comprises friction elements configured to reduce relative slippage of the rein.

16. The hand grip of claim 1, wherein the clamp comprises a collet having first and second collet sections.

17. The hand grip of claim 16, wherein the first inner surface is formed by the first collet section and the second inner surface is formed by the second collet section.

18. An adjustable hand grip for an equestrian rein comprising:
a housing comprising an outer surface and opposing, first and second inner surfaces, the first and second inner surfaces at least partially defining a channel passing through the outer surface of the housing, wherein the channel is configured to permit the rein to pass laterally into the channel from outside the housing to a location between the first and second inner surfaces; and
a clamp comprising a clamp member associated with the first inner surface, the clamp member configured to effectively move toward, and alternatively, away from the second inner surface, wherein the clamp is configured to selectively immobilize the rein when the rein is passed through the channel and placed between the first and second inner surfaces;
wherein the outer surface of the housing comprises one or more grip surfaces shaped to conform to an interior shape of a palm of a closed human hand.

19. An adjustable hand grip for an equestrian rein comprising:
a housing comprising an outer surface wherein a passageway extends through the outer surface of the housing from a first side of the housing to an opposite second side, the passageway configured to receive the equestrian rein therein, wherein the housing comprises a frustoconical interior surface; and
a collet positioned within the housing and comprising a first inner surface and a frustoconical outer surface, wherein the first inner surface is configured to effectively move toward, and alternatively, away from an opposing, second inner surface, and wherein the collet is configured to selectively immobilize the rein when the rein is positioned within the passageway between the first and second inner surfaces;
wherein the outer surface of the housing defines one or more grip surfaces shaped to conform to an interior shape of a palm of a closed human hand.

20. The hand grip of claim 19, wherein the frustoconical interior surface of the housing is configured to engage the frustoconical outer surface of the collet to move the first inner surface toward the second inner surface.

21. The hand grip of claim 20, wherein the housing comprises two halves threadably engaged with one another, and wherein rotation of one of the housing halves relative to the other housing half causes the frustoconical interior surface of the housing to slide along the frustoconical outer surface of the collet.
